(19) United States
(12) Patent Application Publication
(10) Pub. No.: US 2013/0204650 A1
(43) Pub. Date: Aug. 8, 2013

(54) SYSTEM AND METHOD FOR COMPLIANCE MANAGEMENT

(71) Applicant: Navin Sabharwal, New Delhi (IN)

(72) Inventor: Navin Sabharwal, New Delhi (IN)

(73) Assignee: HCL AMERICA INC., SUNNYVALE, CA (US)

(21) Appl. No.: 13/364,406

(22) Filed: Feb. 2, 2012

(51) Int. Cl. G06Q 10/06

(52) U.S. Cl. 705/7.13

(57) ABSTRACT

A system and method to manage SLA compliance customer services comprises an estimation engine to perform an automated estimation of a probability of SLA violation for a trouble ticket that indicates and operation incident that is to be resolved. The automated estimation may produce a risk value that trigger an escalation module to automatically perform a pre-emptive action if the risk values are higher than a threshold value, to promote resolution of the trouble ticket prior to SLA violation. The pre-emptive action may comprise sending an alert message to one or more operators associated with the ticket. The automated estimation may be based at least in part on compliance information for past tickets.

### BACKGROUND

A service-level agreement (SLA) is an agreement between a customer and a service provider for an agreed level of service. A penalty clause may be included in the agreement, making the service provider liable for fines or losses in revenue in the event of SLA violation. To ease SLA compliance verification, the service provider may set SLA values or SLA thresholds for respective services to which the SLA pertains.

Service providers who provide support services (e.g., to support information technology (IT) services and/or infrastructure) may operate under an SLA. In such cases, the service provider may be notified of an operational problem with an IT system component by means of a trouble ticket that identifies one or more parameters of the operational problem. Thus, where a server, client computer, application, or the like malfunctions or fails, a trouble ticket may be submitted to the service provider. The relevant SLA may define a target resolution time within which the trouble ticket should be resolved in order to comply with the SLA, without incurring an SLA violation. Different target resolution times may apply to different types of trouble tickets or operational problems.

### BRIEF DESCRIPTION OF DRAWINGS

Some embodiments are illustrated by way of example and not limitation in the figures of the accompanying drawings, in which like reference numerals indicate like components. In the drawings:

FIG. 1 is a high-level schematic diagram illustrating a system to provide SLA compliance management, in accordance with an example embodiment.

FIG. 2 is a lower-level schematic diagram illustrating a customer support system that comprises an SLA compliance management system in accordance with a further example embodiment.

FIG. 3 is a diagrammatic view of SLA compliance management application(s) forming part of the configuration management system of FIG. 2.

FIG. 4 is a flow chart illustrating an example embodiment of a method to SLA compliance, according to an example embodiment.

FIG. 5 is flow chart illustrating another example embodiment of a method to manage SLA compliance.

FIG. 6 is flow chart illustrating a further example embodiment of a method to manage SLA compliance.

FIG. 7 is a block diagram of a machine in the example form of a computer system within which a set instructions for causing the machine to perform any one or more of the methodologies discussed herein may be executed.

### DETAILED DESCRIPTION

In the following description, for purposes of explanation, numerous specific details are set forth in order to provide a thorough understanding of some example embodiments. It will be evident, however, to one of ordinary skill in the art that embodiments of the present disclosure may be practiced without these specific details.

According to one example embodiment, there is provided a computer-implemented method comprising receiving a trouble ticket that indicates an operational problem or incident that is to be resolved by a customer support system, performing an automated estimation of a probability of Service Level Agreement (SLA) violation for the trouble ticket, and automatically performing a pre-emptive action to promote resolution of the trouble ticket prior to SLA violation if results of the automated estimation satisfy predefined criteria.

The method may further comprise determining one or more parameters of the trouble ticket or incident ticket, the automated estimation being based at least in part on the one or more parameters of the trouble ticket. The one or more parameters of the trouble ticket may include a response time that indicates elapsed time since reception of the trouble ticket. The applicable SLA may specify respective target resolution times within which incidents connected to different types of trouble tickets are to be resolved. The automated estimation may in such cases include a comparison between the response time and the corresponding target resolution time. The probability of SLA violation for a particular type of trouble ticket, in accordance with the automatic estimation, typically increases as the response time approaches the corresponding target time. For example, an incident ticket for accessing a particular application may be created through a phone mode, for example by a telephone call, and in situations where no helpdesk is responding to a phone call, it may lead to a response time SLA breach and may in turn affect overall time to resolve the application access ticket.

The estimation of the risk of SLA violation may further be based at least in part on the current work status of the trouble ticket, which may be reflected in worklog updates with respect to the particular trouble ticket. A current work status that indicates, for example, that the associated trouble ticket has been resolved, will result in the automated estimation of the probability of SLA violation indicating that there is no probability of SLA violation, with the result that no pre-emptive action will be executed with respect to the associated trouble ticket.

Automatic estimation of SLA violation risk may further be based at least in part on an indicator of the number of times the trouble ticket has been transferred between operators. The indicator for the number of times the trouble ticket has been transferred between operators may be incremented each time the trouble ticket is transferred. Such inter-operator transfers are referred to herein as “hops.” The estimated probability of SLA violation may be proportional to the number of times the ticket has been transferred. The estimated probability of SLA violation for a particular trouble ticket may thus increase with an increase in the associated number of hops, all other things being equal.

The pre-emptive action may comprise generating an alert message indicating that attention to the trouble ticket is desired, and sending the alert message to at least one operator. An alert message may instead or in addition be sent to all operators within an assigned group of operators, including a superior of the particular operator tasked with resolving the ticket.

The automated estimation may produce a violation risk value indicative of the probability of SLA violation for the trouble ticket, the method further comprising determining that the violation risk value is relatively high, the preemptive action being performed responsive to the determination that the risk value is relatively high. Determination that the SLA violation risk value is relatively high may comprise determining that the violation risk value is greater than a predefined threshold value.

The method may further comprise receiving a further trouble ticket with respect to another operational problem or incident that is to be resolved by the customer support system, performing the automated estimation of the probability of SLA violation for the further trouble ticket, determining that the probability of SLA violation for the further trouble ticket is relatively low, and consequently performing no pre-emptive action with respect to resolution of the further trouble ticket. The method may in such case further comprise repeatedly performing the automated estimation with respect to the further trouble ticket on an ongoing basis until it is determined that the probability of SLA violation for the further trouble ticket is relatively high (e.g., compared to other pending tickets, or a selected threshold), and in response to the determination, automatically performing the pre-emptive action with respect to the further trouble ticket to promote resolution of the further trouble ticket prior to SLA violation. The automated estimation may thus continually be performed with respect to a plurality of trouble tickets in a ticket queue, and, in response to determining that the probability of SLA violation for a particular one of the plurality of trouble tickets is relatively high, automatically performing the pre-emptive action with respect to the particular trouble ticket.

Historical ticket information with respect to past trouble ticket resolution may be retrieved, the automated estimation being based at least in part on the historical ticket information. The system may in such cases include a memory or database which stores the historical ticket information. The automated estimation may include identifying one or more similar past tickets indicated in the historical ticket information, and determining past adherence information for the similar past trouble tickets, the estimated probability of SLA violation being based at least in part on the past adherence information. Adherence information may comprise information with respect to SLA violation/non-violation for the past trouble tickets. Identification of the similar past tickets may be based on comparing one or more attributes of the trouble tickets with corresponding attributes in the historical ticket information. In instances, for example, where a particular type of problem with respect to a particular type of configuration item or information system component has in the past proved problematic and have resulted in SLA violations, the past adherence information for a new trouble ticket for the same type of problem on the same type of configuration item may indicate a greater probability of SLA violation for the new trouble ticket than would otherwise have been the case.

The method may further comprise, responsive to conclusion of the trouble ticket (e.g., by resolving the incident associated with the trouble ticket or closing the trouble ticket), updating the historical ticket information to include data with respect to resolution of the trouble ticket. Conclusion of the trouble ticket may comprise resolution of the trouble ticket to avoid SLA violation, or, instead, may comprise an SLA violation of the trouble ticket.

### Architecture

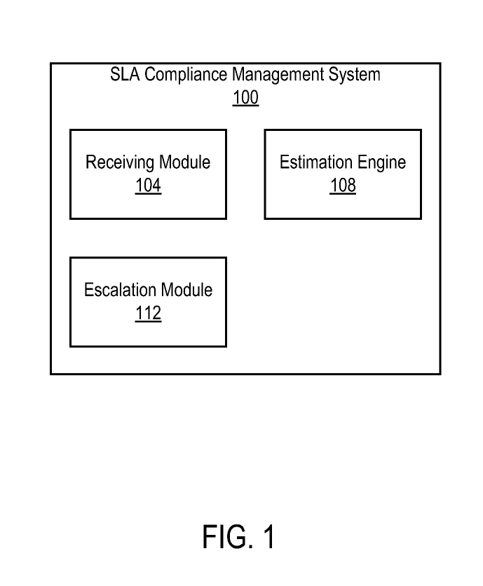

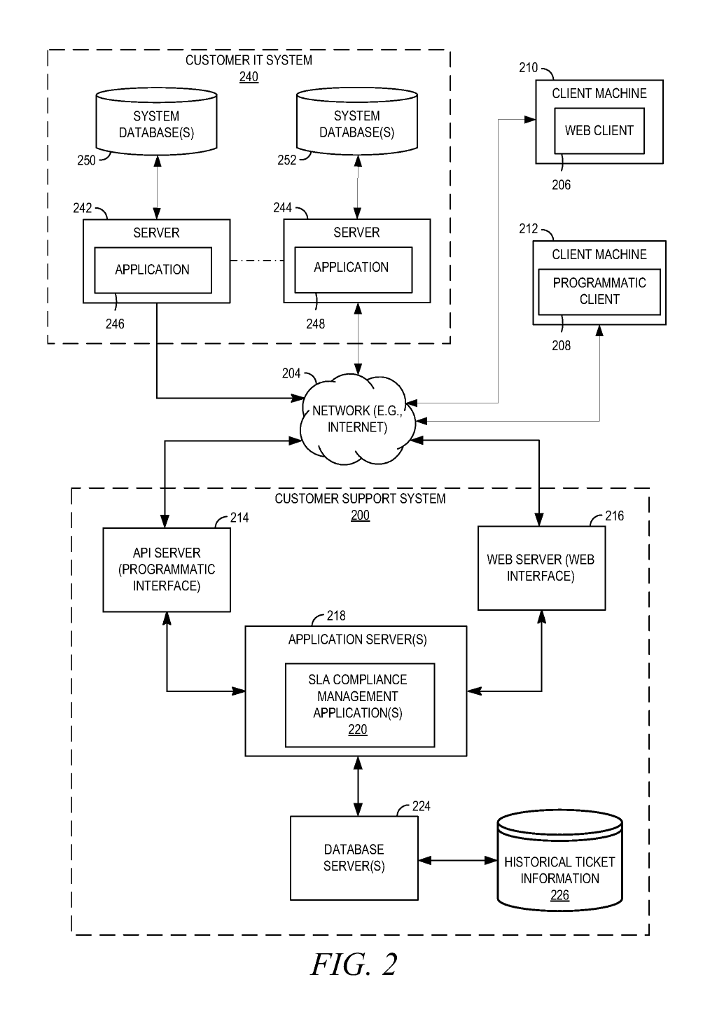

FIG. 1 is a high-level schematic diagram of one embodiment of an example SLA compliance management system 100 to promote SLA compliance for trouble tickets. The example system 100 comprises modules that supply support services to one or more IT systems (see FIG. 2). The system 100 thus comprises a receiving module 104 to receive trouble tickets that indicate operational problems in a customer system, the operational problems to be resolved by a customer support system of which the SLA compliance management system 100 may form part.

The system 100 also comprises an estimation engine 108 to perform an automated estimation of the probability of SLA violation for the trouble ticket. The automated estimation or calculation performed by the estimation engine 108 may be based on parameters of the trouble ticket, and may based in part on past performance information for similar or identical trouble tickets, as is described in greater detail below with reference to FIGS. 2, 3, and 6.

The system 100 may further comprise an escalation module 112 to perform a pre-emptive action to promote resolution of the trouble ticket prior to SLA violation. The escalation module 112 may be configured to automatically perform the pre-emptive action responsive to a determination that the probability of SLA violation for the relevant trouble ticket is significant or is relatively high, based on the automated estimation of SLA violation probability.

FIG. 2 is a schematic network diagram that shows a more detailed view of a customer support system 200 that comprises an SLA compliance management system similar to or identical to that described with reference to FIG. 1, in accordance with an example embodiment. FIG. 2 shows a client-server architecture, within which an example embodiment of the customer support system 200 may be deployed. In the embodiment of FIG. 2, the customer support system 200 provides server-side functionality, via a network 204 (e.g., the Internet, a Wide Area Network (WAN), or a Local Area Network (LAN), to one or more clients machines. FIG. 2 illustrates, for example, a web client 206 (e.g., a browser, such as the Internet Explorer browser developed by Microsoft Corporation of Redmond, Wash.), and a programmatic client 208 executing on respective client machines 210 and 212.

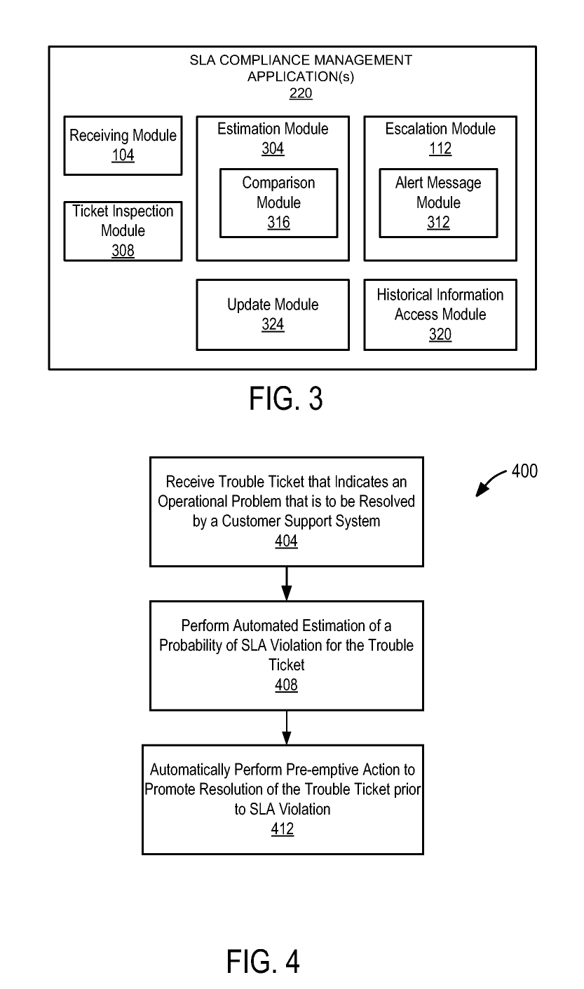

An Application Program Interface (API) server 214 and a web server 216 are coupled to, and provide programmatic and web interfaces respectively to, one or more application servers 218. The application servers 218 host one or more SLA compliance management applications 220 (see also FIG. 3). The application server(s) 218 are, in turn, connected to one or more databases server(s) 224 that facilitate access to one or more database(s) that includes information with respect to past performance with respect to SLA compliance, in the present example being historical ticket information 226. The historical ticket information 226 may include statistical information with respect to past trouble tickets received by the customer support system 200, for example indicating SLA violation/compliance history for trouble tickets having particular parameters or characteristics.

The customer support system 200 is also in communication with a customer Information Technology (IT) system 240 for which the customer support system is, inter alia, to provide customer support by resolving operational issues raised by trouble tickets submitted by the customer IT system 240. The customer IT system 240 has an IT infrastructure comprising multiple IT components. The customer IT system 240 may, for example, be a client enterprise system that supports a business enterprise. The customer IT system 240 may, e.g., include IT components in the form of servers 242, 244, software applications 246, 248, and system databases 250, 252. It will be appreciated that the enterprise system 240 may comprise a large number of process servers 242, 244 and process datastores 250, 252; FIG. 2 shows only two such process servers 242, 244, for ease of explanation. Further components of the customer IT system 240 may include various user devices or endpoint devices such as, for example, user terminals or client computers, software applications executing on user devices, printers, scanners, and the like.

The SLA compliance management application(s) 220 may provide a number of automated functions for promoting or facilitating SLA compliance and may also provide a number of functions and services to users that access the system 200, for example providing analytics, diagnostic, predictive and management functionality relating to resolution of trouble tickets. Respective modules for providing these functionalities are discussed in further detail with reference to FIG. 3 below. While all of the functional modules, and therefore all of the SLA compliance management application(s) 220 are shown in FIG. 2 to form part of the customer support system 200, it will be appreciated that, in alternative embodiments, some of the functional modules or process model applications may form part of systems that are separate and distinct from the customer support system 200, for example to provide outsourced SLA compliance management for a customer support system.

The web client 206 accesses the SLA compliance management application(s) 220 via the web interface supported by the web server 216. Similarly, the programmatic client 208 accesses the various services and functions provided by the SLA compliance management application(s) 220 via the programmatic interface provided by the API server 214.

Further, while the system 200 shown in FIG. 2 employs a client-server architecture, the example embodiments are not limited to such an architecture, and could equally well find application in a distributed, or peer-to-peer, architecture system, for example. The SLA compliance management application(s) 220 could also be implemented as standalone software programs, which do not necessarily have networking capabilities.

### SLA Compliance Management Application(s)

FIG. 3 is a block diagram illustrating multiple functional modules of the SLA compliance management application(s) 220 of the exemplary customer support system 200 of FIG. 2. Although the example modules are illustrated as forming part of a single application, it will be appreciated that the modules may be provided by a plurality of applications The modules of the application(s) 220 may be hosted on dedicated or shared server machines (not shown) that are communicatively coupled to enable communications between the server machines. The modules themselves are communicatively coupled (e.g., via appropriate interfaces) to each other and to various data sources, so as to allow information to be passed between the modules or so as to allow the modules to share and access common data. The modules of the application(s) 220 may furthermore access the historical ticket information 226 via the database server(s) 224.

The SLA compliance management application(s) 220 may include the receiving module 104 and the escalation module 112, as described above with reference to FIG. 1. The SLA compliance management application(s) 220 may further include an estimation module 304 that is configured to provide a hardware-implemented estimation engine 108 (as described with reference to FIG. 1), when executed by one or more computer processors.

The application(s) 220 may further comprise a ticket inspection module 308 to determine one or more parameters of trouble tickets submitted to the customer support system 200. Automated estimation of SLA violation probability may be based at least in part on trouble ticket parameters determined by the ticket inspection module 308. The estimation module 304 may be configured to produce a violation risk value or a violation risk score indicative of the estimated probability of SLA violation for respective trouble tickets. The estimation module 304 may further include a comparison module 316 to determine whether the violation risk value is relatively high and whether pre-emptive action to promote SLA compliance is therefore appropriate, e.g., by comparing the calculated risk violation value to a predefined threshold value.

The escalation module 112 may include an alert message module 312 to generate an alert message to indicate that attention to the relevant trouble ticket is required. The alert message may automatically be sent to one or more operators associated with the trouble ticket.

A historical information access module 320 may be provided to access the historical ticket information 226, in which case the automated SLA violation probability estimation may be based at least in part on retrieved historical ticket information. The historical information access module 320 may be configured to identify in the historical ticket information 226 information with respect to one or past tickets that are similar to a currently considered trouble ticket, and to determine past adherence information for the similar past trouble tickets.

The SLA compliance management application(s) 220 may yet further include an update module 324 to update the historical ticket information 226 responsive to conclusion of each trouble ticket, so that the historical ticket information 226 includes data with respect to resolution of the incident associated with the trouble ticket and/or SLA violation with respect to the trouble ticket, as the case may be.

Further functionality of the SLA compliance management application(s) 220 will be evident from description below of example embodiments of a method of managing configuration of components in the customer IT system 240.

### Flowcharts

FIG. 4 is a flow chart illustrating, at a high level, a method 400, in accordance with an example embodiment, to manage SLA compliance in a customer support system. The method 400 may be performed by any of the modules, logic, or components described above with reference to FIGS. 1-3. The method 400 may comprise receiving a trouble ticket, at operation 404, the trouble ticket indicating an operational problem in the customer IT system 240 that is to be resolved by the customer support system 200. An automated estimation or calculation of a probability of SLA violation for the trouble ticket may thereafter be performed, at operation 408, e.g. to produce a violation risk value indicative of the probability or risk of SLA violation. Based on the automated SLA violation risk estimation, a pre-emptive action may be performed, at operation 412, to promote or facilitate resolution of the trouble ticket prior to SLA violation, for example by generating and sending an alert message to one or more operators associated with the trouble ticket.

An example of a resolved trouble ticket is discussed below. Parameters or attributes for each trouble ticket may, for example, include: a type of incident or issue; a type of IT component or configuration item associated with the issue; an assignee identifying a particular operator to which the ticket is assigned for resolution; an assignee group to which the assignee belongs; an indicator of the number of times the troubled ticket has been transferred between operators, also referred to herein as the number of ticket hops; a response time that is indicative of an elapsed time since reception of the trouble ticket; and a current status or worklog update of the ticket, indicating the latest entry in a worklog by an operator with respect to the ticket to indicate status of the ticket resolution process, e.g., indicating that the trouble ticket is pending, resolved, etc. The above-described attributes are not exhaustive and may be augmented or reduced depending on the particular ticketing environment.

In the example, a trouble ticket is submitted to reset a password for a mail account. Based on the attributes or parameters of the trouble ticket, a target resolution time for the trouble ticket, according to the associated SLA, is determined to be 30 minutes. If the issue is not resolved by resetting the password of the mail account within 30 minutes of reception of the ticket, an SLA violation for the trouble ticket occurs.

The example trouble ticket may have the following parameters:

| Ticket Attribute | Value |
|---|---|
| Type Of Incident | Password Reset |
| Type of Configuration Item | Mail Server |
| Assignee Group | MS Exchange |
| Assignee | A |
| Hops | 0 |
| Response Time | 15 |
| Worklog Updates | Issue Resolved |

Referring to the table, it can be seen that in this case, the trouble ticket was assigned to operator A. The current status represented by the worklog update field indicates that the issue has been resolved and that there were no ticket hops for the ticket. The number of ticket hops may be useful in determining whether or not an incorrect assignation was made for the ticket. In the above example, the fact that there were no ticket hops for the resolved ticket indicates that the ticket was assigned to an appropriate assignee group.

In this example, the ticket has been resolved and there is therefore no need to estimate a risk of SLA violation. Prior to resolution of the operational problem (in this example, resetting the password), the risk or probability of SLA violation would have been relatively low since a further 15 minutes would remain to resolve the issue, and the number of hops is 0. Had the elapsed time however been higher, for example being higher than 20 minutes or approaching the SLA target resolution time, the risk of SLA violation would have been higher as well. A greater indicated number of hops would likewise have corresponded to greater SLA violation risk, pointing to a resolution of the issue that might be problematic, or incorrect or inappropriate assignment to an operator.

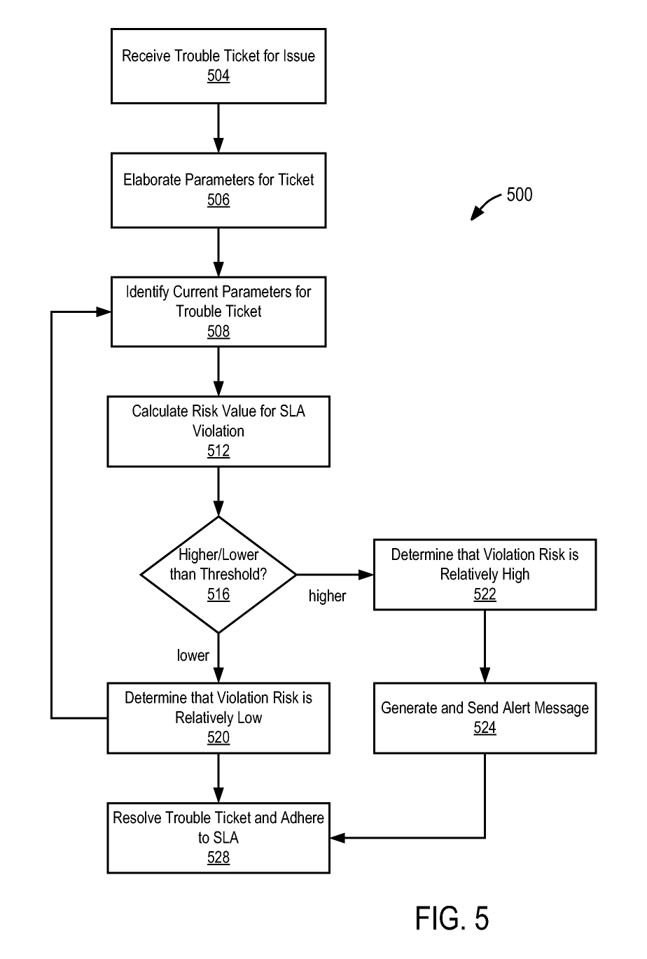

FIG. 5 is a flowchart illustrating in greater detail an example method 500 to manage SLA compliance in accordance with the example embodiment. Referring now to FIGS. 1, 2, and 5, it can be seen that the method 500 may be initiated at operation 504 when a trouble ticket is received by the SLA compliance management system 200 for an incident comprising an operational problem in the customer IT system 240. The trouble ticket may be automatically generated and sent to the system 200 responsive to failure of a hardware component or an application. Instead, or in addition, the trouble ticket may be submitted by a user of the customer IT system 240 via a ticketing application provided in the customer IT system 240. In this example, a password may be reset for an application, and an incident ticket is created, at operation 504.

The trouble ticket may have various attributes or parameters associated with it, as described above with reference to the example resolved incident ticket. Some of the parameters may be attached to the ticket upon its creation or generation, while some of the parameters may be associated with the ticket subsequent to its reception by the system 200, and may be updated during processing of the ticket at the customer support system 200.

A particular SLA and associated SLA parameters (e.g., a target resolution time) may be determined based on the attributes of the trouble ticket. Once the trouble ticket is received, the ticket may be entered in a ticket queue comprising a plurality of trouble tickets that are pending. Thus, subsequent to reception of the example trouble ticket, the ticket parameters are elaborated, at operation 506, to include, at least some of the parameters discussed above with reference to the example resolved trouble ticket.

In an example, the trouble ticket is assigned to a mainframe track or an assignee group tasked with mainframe incidents, and an assigned operator may commence resolution of the ticket. Based on SLA information which is automatically accessed, it is determined that this type of ticket carries a target response time or response SLA (e.g., a maximum time within which a response to the ticket is required) of 30 minutes and a target resolution time or response SLA (e.g., a maximum time within which resolution of the ticket is required) of 4 hrs. In this example, the ticket is assigned to a level 1 assignee X within 10 minutes and starts working on the ticket, thus meeting the response time of 30 minutes.

At operation 508, the latest parameters for the trouble ticket are identified. Thereafter, a risk value for SLA violation is calculated at operation 512, based on the latest ticket parameters. Because the target response time has been satisfied, there have been no hops for the ticket, and a relatively small fraction of the target resolution time has expired, a relatively low risk value of SLA violation is produced by the calculation.

The calculated risk value of SLA violation is compared to a predefined threshold, at operation 516. The calculated risk value is lower that the threshold, and it is thus determined, at operation 520, that the violation risk is relatively low.

As a result, no pre-emptive action is taken with respect to the trouble ticket. Updating of the ticket parameters and calculation of the risk value is performed repeatedly or continually, with no pre-emptive or remedial action being taken as long as the calculated risk value is determined to be relatively low (e.g., it does not exceed a selected threshold of probability).

In the instance of the example trouble ticket, assignee X realizes after working on the ticket for 20 minutes that the ticket needs to be assigned to a different assignee group, e.g., an MS Windows track. A ticket hop takes place and is assigned to assignee Y. The worklog is updated accordingly by assignee X. If three hours have elapsed without resolution of the ticket, risk value calculated at operation 512 may be higher than the threshold and it may thus be determined, at operation 522, that the violation risk is relatively high. The risk value may, e.g., be proportional to the number of hops (in a further example being proportional to the number of hops divided by the possible number of hops) and to the relationship between the elapsed time and the target resolution time. Calculation of a high violation risk value in the present example may thus result from the ticket parameters indicating that there has been one or more ticket hops, that the elapsed response time is nearing the target resolution time, and that the worklog update indicates that the ticket is pending.

Responsive to determining that the calculated violation risk is relatively high (e.g., it exceeds a selected threshold of probability), at operation 522, triggers automatic performance of a pre-emptive action to promote SLA compliance, in this example being the automatic generation and sending of an alert message, at operation 524. The alert message may be sent to the currently assigned operator, and may in addition be sent to the entire assignee group associated with the ticket. In an example, the alert message is sent to the entire Windows track mailing list as well as to assignee Y. Responsive to the alert message, the trouble ticket may be escalated within the relevant support group, and may be assigned to a level 2 operator.

In some embodiments, the risk value for the ticket may continue to be calculated, at operation 512, subsequent to sending the alert message, e.g. being calculated intermittently or periodically. Further alert messages and/or other pre-emptive actions or escalation actions may be performed responsive the calculated risk value increasing above further threshold values.

When the newly assigned level 2 operator, in the current example instance, works on the trouble ticket and resolves it within the SLA target resolution time, at operation 528, SLA violation is avoided, due in part to the pre-emptive alert message.

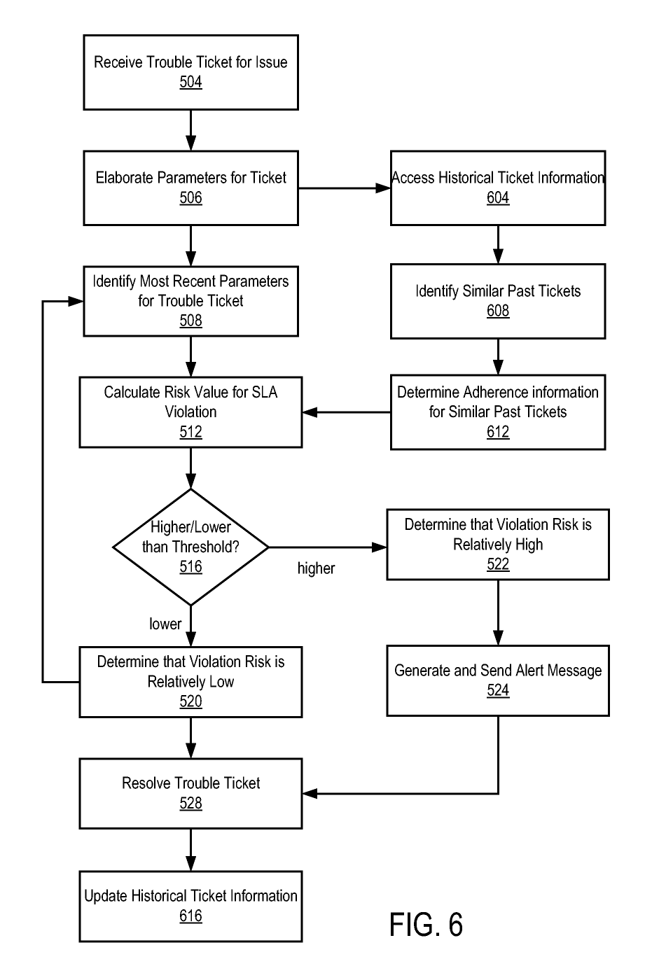

FIG. 6 is a flow chart illustrating a further example method 600 to manage SLA compliance in a customer support system. The method 600 is analogous to the method 500 exemplified with reference to FIG. 5, a major distinction being that automatic estimation of the risk of SLA violation is based at least in part on historical ticket information, such as adherence statistics of similar past tickets.

In the example method 600 of FIG. 6, an incident ticket is created and is received, at operation 504, responsive to an operational problem in the customer system 240 in the form of a local area network (LAN) connection going down. The ticket is entered in the ticket queue and is assigned to a Networks Track assignee group. The parameters associated with the ticket, e.g., bandwidth of the connection, impact, time of detection, and the like are recorded, and other parameters for the ticket are elaborated, at operation 506.

At operation 604, the historical ticket information 226 is accessed and the database of information with respect to historical resolution of past tickets is searched to identify past tickets that are similar to the current ticket, at operation 608. The particular criteria used to identify a set of similar past historical tickets may be contained in a predefined business rule. The number of similar past tickets identified may thus vary depending on the applicable similarity criteria. For example, the number of similar past tickets identified, on the one hand, based on similarity criteria defined to identify all past tickets which relate to the same type of configuration item as the current ticket will be smaller than the number of similar past tickets identified, on the other hand, based on similarity criteria defined to identify all past tickets which relate to the same type of problem and the same type of configuration item as the current trouble ticket. In this example, the historical ticket information 226 is searched for similar tickets that are related to disconnected LAN cables, or insufficient bandwidth issues.

Thereafter, adherence information of the relevant similar past ticket information is determined, at operation 612. The SLA compliance for the prior similar tickets is thus retrieved from the historical ticket information 226. Such past adherence information may be in the form of statistical SLA compliance/violation information, and may include information with respect to resolution times and numbers of hops prior to resolution.

The relevant adherence information is used as an input to calculation of risk value for SLA violation, at operation 512. The calculated risk value may be proportional to past SLA violation of the relevant similar past tickets, so that the calculated risk value based on a higher past SLA violation rate may be higher than a risk value based on a lower past SLA violation rate, all other things being equal.

The remainder of the method 600 proceeds similarly to the comparable operations in the method 500 of FIG. 5, with the exception that the historical ticket information 226 is updated, at operation 616, subsequent to resolution of the trouble ticket, at operation 528. Resolution of the current trouble ticket relative to the corresponding SLA is thus factored into the historical ticket information 226 for use in future tickets, so that the method includes a feedback loop, and is thus self-learning.

A further example of automatic estimation of a probability of SLA violation, for example by calculating a risk value, by use of the system 200 (see FIG. 2) in accordance with the method 600 (see FIG. 6) will now be described with reference to a ticket requesting password reset for a particular application.

It is determined that the total number of tickets of the relevant type, i.e. with respect to password reset, received during an associated measurement period is 442. It is further determined that the number of these historical tickets that violated an associated SLA for password reset equals 23. An incident type risk index reflective of the historical trend with respect to password reset tickets is obtained, in this example, by calculating the percentage of historical password reset tickets that resulted in SLA violations, in this example being 23/442*100=5.2%.

A response time risk index associated with is further calculated by the formula (100/Target Average Response Time). In this example, the target SLA for response time is 15 hours, and the response time risk index is thus 100/15=6.67.

A group hop risk index is further calculated to provide an indication of a group hop risk value increase for each additional hop. To this end, the average number of group hops per ticket for the related type of incident is obtained. In this example, the number of group hops in the relevant category (e.g. password reset instance) during the measurement period is 146. Bearing in mind that the number of tickets for password resets in the measurement period is 442, the average group hops per ticket is 146/442=0.33.

An average number of group hops per violated ticket during the measurement period is obtained by dividing the total number of group hops for password reset tickets that violated the SLA during the measurement period by the number of tickets that violated the SLA for password reset. In this example, the total group hops for violated tickets is 71, and the average number of group hops per violated ticket is therefore 71/23=3.09. The group hop risk index is calculated by the formula (100/Average Group Hops per Violated Ticket)*Average Group Hops per Ticket. The group hop risk index in this example is therefore (100/3.09)*0.33=10.7.

A cumulative risk value is finally calculated by summing risk values associated with the type of incident, the number of hops, and the response time, respectively. The risk value for the type of incident is, in this embodiment, equal to the risk index, in this example being 5.2. The risk value for the number of hops is calculated by multiplying the number of hops with the group hop risk index. In this instance there have been two group hops for the relevant ticket, and the group hop risk value is therefore 2*10.7=21.4. The response time risk value is calculated by multiplying the current response time for the ticket under consideration but with the response time risk index, in this example being 10*6.67=66.67. The resultant risk value for the incident ticket in the above example is therefore 5.2+21.4+66.67=93.27.

The calculated risk value of 93.27 is compared (e.g. at operation 516 in FIG. 5 or 6) to a predefined threshold value, to establish whether the violation risk is relatively high or relatively low. In this example, the threshold value is 70%, and the violation risk for the current incident ticket is automatically determined to be relatively high, so that one or more alert message is automatically generated and sent, at operation 524, for the ticket. It will be appreciated that different predetermined threshold values may be used in other embodiments.

Automatic calculation of a risk value for an incident ticket in accordance with the method 500 described with reference to FIG. 5 may be calculated in a manner analogous to that described above, but without having reference to historical performance information. Instead, static predefined values or SLA target values with respect to which risk indices and/or risk values are calculated may be employed, to arrive at a cumulative risk value. It will be appreciated that different mathematical models and/or formulae may be used, in other embodiments, to calculate risk values, and that such mathematical models or formulae may include different and/or additional ticket attributes than those used in the above exemplified embodiment.

In many embodiments, the above-described example method and system advantageously provide an effective mechanism to reduce or limit SLA non-compliance. An alert may automatically be generated when the probability of an SLA breach is high, so that the incident ticket can be analyzed and given appropriate attention before it actually breaches and SLA and a penalty is imposed. Use of compliance statistics for similar past tickets in calculation of a risk value of SLA violation may promote predictive accuracy of the calculated risk value, which accuracy may be promoted by including a feedback loop in the system.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs)).

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

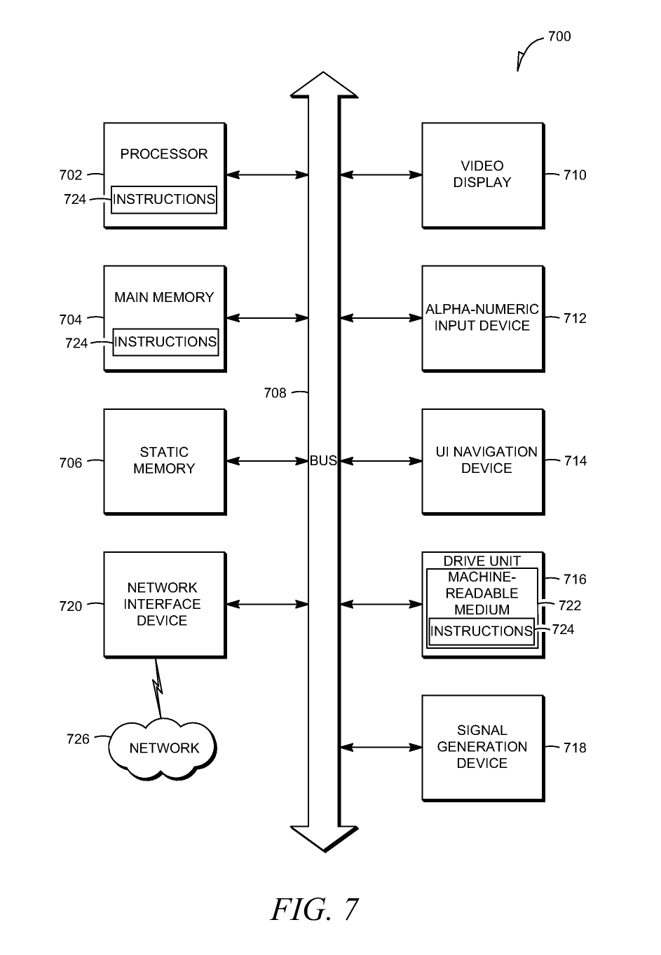

FIG. 7 is a block diagram of machine in the example form of a computer system 700 within which instructions for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor 702 (e.g., a central processing unit (CPU), a graphics processing unit (GPU) or both), a main memory 704 and a static memory 706, which communicate with each other via a bus 708. The computer system 700 may further include a video display unit 710 (e.g., a liquid crystal display (LCD) or a cathode ray tube (CRT)). The computer system 700 also includes an alphanumeric input device 712 (e.g., a keyboard), a user interface (UI) navigation device 714 (e.g., a mouse), a disk drive unit 716, a signal generation device 718 (e.g., a speaker) and a network interface device 720.

### Machine-Readable Medium

The disk drive unit 716 includes a machine-readable medium 722 on which is stored one or more sets of data structures and instructions 724 (e.g., software) embodying or utilized by any one or more of the methodologies or functions described herein. The instructions 724 may also reside, completely or at least partially, within the main memory 704 and/or within the processor 702 during execution thereof by the computer system 700, the main memory 704 and the processor 702 also constituting machine-readable media.

While the machine-readable medium 722 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present disclosure, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 724 may further be transmitted or received over a communications network 726 using a transmission medium. The instructions 724 may be transmitted using the network interface device 720 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A system comprising:
a receiving module to receive a trouble ticket that indicates an operational problem that is to be resolved by a customer support system;
an estimation engine to perform an automated estimation, using one or more processors, of a probability of Service Level Agreement (SLA) violation for the trouble ticket; and
an escalation module to automatically perform a pre-emptive action to promote resolution of the trouble ticket prior to SLA violation, based on results of the automated estimation.

2. The system of claim 1, further comprising a ticket inspection module to determine one or more parameters of the trouble ticket, the automated estimation being based at least in part on the one or more parameters of the trouble ticket.

3. The system of claim 2, wherein the one or more parameters of the trouble ticket includes a response time that indicates elapsed time since reception of the trouble ticket.

4. The system of claim 2, wherein the one or more parameters of the trouble ticket includes a current work status of the trouble ticket.

5. The system of claim 2, wherein the one or more parameters of the trouble ticket includes an indicator of the number of times the trouble ticket has been transferred between operators.

6. The system of claim 1, wherein the automated estimation is such that the estimated probability of SLA violation is proportional to a number of times the ticket has been transferred between operators.

7. The system of claim 1, wherein the escalation module comprises an alert message module to generate an alert message indicating that attention to the trouble ticket is desired, and to send the alert message to at least one operator.

8. The system of claim 1, wherein the estimation engine is to produce a violation risk value indicative of the probability of SLA violation for the trouble ticket, the estimation engine further being configured to determine that the violation risk value is relatively high compared to a predefined threshold value, the escalation module being configured to perform the pre-emptive action responsive to the determination that the risk value is relatively high.

9. The system of claim 8, further comprising a comparison module to determine that the violation risk value is relatively high by determining that the violation risk value is greater than the predefined threshold value.

10. The system of claim 8, further configured to:
receive a further trouble ticket with respect to another operational problem that is to be resolved by the customer support system;
perform the automated estimation of the probability of SLA violation for the further trouble ticket;
determine that the probability of SLA violation for the further trouble ticket is relatively low compared to the predefined threshold value; and
responsive to the determination of the relatively low probability, perform no pre-emptive action with respect to resolution of the further trouble ticket.

11. The system of claim 10, wherein the estimation engine is configured repeatedly to perform the automated estimation with respect to the further trouble ticket on an ongoing basis until it is determined that the probability of SLA violation for the further trouble ticket is relatively high compared to the predefined threshold value, the escalation module being configured automatically to perform the pre-emptive action with respect to the further trouble ticket responsive to the determination, to promote resolution of the further trouble ticket prior to SLA violation.

12. The system of claim 1, wherein the estimation engine is configured continually to perform the automated estimation with respect to a plurality of trouble tickets in a ticket queue, and, the escalation module being configured automatically perform the pre-emptive action with respect to a particular trouble ticket, in response to determining that the probability of SLA violation for a particular one of the plurality of trouble tickets is relatively high compared to the predefined threshold value.

13. The system of claim 1, further comprising a historical information access module to retrieve historical ticket information with respect to past trouble ticket resolution, the automated estimation being based at least in part on the historical ticket information.

14. The system of claim 13, wherein the historical information access module is configured automatically to identify one or more similar past tickets indicated in the historical ticket information, and to determine past adherence information for the similar past trouble tickets, the estimated probability of SLA violation being based at least in part on the past adherence information.

15. The system of claim 13, further comprising an update module to update the historical ticket information to include data with respect to resolution of the trouble ticket.

16. A computer-implemented method comprising:
receiving a trouble ticket that indicates an operational problem that is to be resolved by a customer support system;
performing an automated estimation, using one or more processors, of a probability of Service Level Agreement (SLA) violation for the trouble ticket; and
automatically performing a pre-emptive action to promote resolution of the trouble ticket prior to SLA violation.

17. The method of claim 16, further comprising determining one or more parameters of the trouble ticket, the automated estimation being based at least in part on the one or more parameters of the trouble ticket.

18. The method of claim 17, wherein the one or more parameters of the trouble ticket includes elapsed time since reception of the trouble ticket.

19. The method of claim 17, wherein the one or more parameters of the trouble ticket includes a current work status of the trouble ticket.

20. The method of claim 17, wherein the one or more parameters of the trouble ticket includes an indicator of the number of times the trouble ticket has been transferred between operators.

21. The method of claim 20, wherein the automated estimation is such that the estimated probability of SLA violation is proportional to the number of times the ticket has been transferred.

22. The method of claim 16, wherein the pre-emptive action comprises generating an alert message indicating that attention to the trouble ticket is desired, and sending the alert message to at least one operator.

23. The method of claim 16, wherein the automated estimation produces a violation risk value indicative of the probability of SLA violation for the trouble ticket, the method further comprising determining that the violation risk value is relatively high compared to a predefined threshold value, the preemptive action being performed responsive to the determination that the risk value is relatively high.

24. The method of claim 23, wherein determining that the violation risk value is relatively high comprises determining that the violation risk value is greater than the predefined threshold value.

25. The method of claim 23, further comprising:
receiving a further trouble ticket with respect to another operational problem that is to be resolved by the customer support system;
performing the automated estimation of the probability of SLA violation for the further trouble ticket;
determining that the probability of SLA violation for the further trouble ticket is relatively low compared to the predefined threshold value; and
responsive to the determination, performing no pre-emptive action with respect to resolution of the further trouble ticket.

26. The method of claim 25, further comprising repeatedly performing the automated estimation with respect to the further trouble ticket on an ongoing basis until it is determined that the probability of SLA violation for the further trouble ticket is relatively high compared to the predefined threshold value, and in response to the determination, automatically performing the pre-emptive action with respect to the further trouble ticket to promote resolution of the further trouble ticket prior to SLA violation.

27. The method of claim 16, further comprising continually performing the automated estimation with respect to a plurality of trouble tickets in a ticket queue, and, in response to determining that the probability of SLA violation for a particular one of the plurality of trouble tickets is relatively high compared to the predefined threshold value, automatically performing the pre-emptive action with respect to the particular trouble ticket.

28. The method of claim 16, further comprising retrieving historical ticket information with respect to past trouble ticket resolution, the automated estimation being based at least in part on the historical ticket information.

29. The method of claim 28, wherein the automated estimation includes identifying one or more similar past tickets indicated in the historical ticket information, and determining past adherence information for the similar past trouble tickets, the estimated probability of SLA violation being based at least in part on the past adherence information.

30. The method of claim 28, further comprising responsive to resolution of the trouble ticket, updating the historical ticket information to include data with respect to resolution of the trouble ticket.

31. A machine-readable storage medium storing instructions which, when performed by a machine, cause the machine to:
receive a trouble ticket that indicates an operational problem that is to be resolved by a customer support system;
perform an automated estimation, using one or more processors, of a probability of Service Level Agreement (SLA) violation for the trouble ticket; and
automatically perform a pre-emptive action to promote resolution of the trouble ticket prior to SLA violation.

32. A means comprising:
means for receiving a trouble ticket that indicates an operational problem that is to be resolved by a customer support system;
means for performing an automated estimation, using one or more processors, of a probability of Service Level Agreement (SLA) violation for the trouble ticket; and
means for automatically performing a pre-emptive action to promote resolution of the trouble ticket prior to SLA violation.
